(19) United States
(12) Patent Application Publication
(10) Pub. No.: US 2019/0176640 A1
(43) Pub. Date: Jun. 13, 2019

(54) APPARATUS FOR DISPLAYING ENVIRONMENT-FRIENDLY VEHICLE INFORMATION WHEN POWER IS SUPPLIED EXTERNALLY, SYSTEM INCLUDING THE SAME, AND METHOD THEREOF

(71) Applicants: Hyundai Motor Company, Seoul (KR); Kia Motors Corporation, Seoul (KR)

(72) Inventors: Jin Hyung Lee, Seoul (KR); Deok Hwan Seo, Incheon (KR); Jong Chan Jun, Hwaseong (KR); Kwon Hyoung Choi, Suwon (KR)

(21) Appl. No.: 15/968,005

(22) Filed: May 1, 2018

(30) Foreign Application Priority Data
Dec. 12, 2017 (KR) 10-2017-0170424

(51) Int. Cl. B60L 11/18; B60W 20/13; B60W 50/14; G01C 21/34

(52) U.S. Cl. CPC B60L 11/1861; B60W 20/13; B60W 50/14; B60L 11/1881; G01C 21/3469; Y10S 903/903; B60W 2900/00; B60W 2510/244; B60W 2560/02; B60L 2250/10; B60L 2240/60; B60W 2050/146

(57) ABSTRACT

An apparatus for displaying environment-friendly vehicle information when power is supplied externally is provided. The apparatus includes an energy source residual amount measuring device that is configured to measure a current energy source residual amount and a per-time energy source consumption and a path generating device that is configured to set a path to a destination. A vehicle controller is configured to calculate a total power usable time period based on the energy source residual amount when a vehicle supplies electric power to the outside. The vehicle controller supplies electric power to the outside when the vehicle travels along the path and adjusts the supply based on the total power usable time period and the power supply allowable time period.

### CROSS-REFERENCE TO RELATED APPLICATION

This application is based on and claims the benefit of priority to Korean Patent Application No. 10-2017-0170424, filed on Dec. 12, 2017, the disclosure of which is incorporated herein in its entirety by reference.

### TECHNICAL FIELD

The present disclosure relates to an apparatus for displaying environment-friendly vehicle information when power is supplied externally, a system including the same, and a method thereof, and more particularly to a technology of predicting a power usable time period based on a current state of a vehicle and an electric power consumption when power is supplied externally and delivering the predicted power usable time period.

### BACKGROUND

Due to the recent high prices of oils and regulation of exhaust gases, environment-friendly policies and improvement of fuel efficiency have become goals in the development of vehicles. Accordingly, the vehicle manufacturers are developing technologies for reducing use of fuels and generation of exhaust gases for the environment-friendly policies and high fuel efficiency.

Particularly, research in the development of technologies such as hybrid electric vehicles (HEVs), plug-in hybrid electric vehicles (PHEVs), and fuel cell electric vehicles (FCEVs), which combine the power of an engine and a motor for high fuel efficiency is actively being conducted. The hybrid electric vehicles satisfy purchase needs of many customers due to the high fuel efficiency and environment-friendly images.

Since the main function of the environment-friendly vehicles is a function as a transportation means, electric energy, by which a vehicle may travel toward a destination, is required to be stored sufficiently. Otherwise, the user should be provided with information necessary to determine a charging need of the vehicle. In particular, an environment-friendly vehicle supplies electric power externally (e.g., a V2G or a mobile power generation vehicle), and thus, a user should receive information, such as, distance to empty using remaining electric power of the vehicle when the electric power is supplied externally.

### SUMMARY

The present disclosure provides an apparatus for displaying environment-friendly vehicle information when electric power is supplied externally, by which a current state and a power usable time period of an environment-friendly vehicle may be predicted when the vehicle supplies electric power externally to allow the user to more easily identify the information, a system including the same, and a method thereof. The technical objects of the present disclosure are not limited to the above-mentioned one, and the other unmentioned technical objects will become apparent to those skilled in the art from the following description.

In accordance with an aspect of the present disclosure, an apparatus for displaying environment-friendly vehicle information may include an energy source residual amount measuring device configured to measure a current energy source residual amount and a per-time energy source consumption, a path generating device configured to set a path toward a destination, a vehicle controller configured to, when a vehicle supplies electric power to the outside, calculate a total power usable time period based on the energy source residual amount and supply electric power to the outside when the vehicle travels along the path, and a display configured to display the total power usable time period and the power supply allowable time period.

The path generating device may set the path as a closest charging station or gas station when a destination is not preset by a user. When the vehicle is an electric vehicle (EV), the energy source may be electric energy, and the vehicle controller may be configured to calculate a power consumption that is a consumption of electrical power supplied to the outside using an in-use current and an in-use voltage of the vehicle. The vehicle controller may further be configured to calculate path use energy which is electric energy necessary for the vehicle to travel along the path, and may be configured to calculate usable energy (e.g., remaining energy) using current residual energy that is the current energy source residual amount and the path use energy. The vehicle controller may further be configured to calculate the power supply allowable time period using the usable energy and the power consumption.

When the vehicle is a hybrid electric vehicle (HEV), the energy source may be a fuel, and the vehicle controller may be configured to calculate a total power usable time period using a current residual fuel amount which is the energy source residual amount and a per-time fuel consumption. The vehicle controller may additionally be configured to calculate a usable power consumption using the current residual fuel amount and a path use fuel amount which is an amount of a fuel that is necessary for the vehicle to travel along the path. The vehicle controller may be configured to calculate the power supply allowable time period using the usable fuel amount and the per-time fuel consumption.

When the vehicle is a fuel cell electric vehicle (FCEV), the energy source may be a fuel, and the vehicle controller may be configured to calculate a total power usable time period using a current residual hydrogen amount which is the energy source residual amount and a per-time hydrogen consumption. The vehicle controller may further be configured to calculate a usable power consumption using the current residual hydrogen amount and a path use hydrogen amount which is an amount of a hydrogen necessary for the vehicle to travel along the path. The vehicle controller may be configured to calculate the power supply allowable time period using the usable hydrogen amount and the per-time hydrogen consumption. The display may then be configured to display the total power usable time period or the power supply allowable time period as numbers, a graph, or a bar graph.

The apparatus may further include a communication device configured to wirelessly transmit the total power usable time period or the power supply allowable time period to a mobile device. The communication device may be configured to transmit the total power usable time period or the power supply allowable time period to the mobile device via Bluetooth communication. The apparatus may further include an alarm device configured to output an alarm through a horn or an emergency light when a final margin time at which the energy source is insufficient, based on the total power usable time period or the power supply allowable time period. The communication device may be configured to transmit the final margin time information to the mobile device via wireless communication. The vehicle controller may be configured to compulsorily stop supply of electric power to the outside or turn off the vehicle when the electric power is continuously supplied to the outside after the alarm regarding the final margin time.

In accordance with another aspect of the present disclosure, a system for displaying environment-friendly vehicle information may include an apparatus configured to display environment-friendly vehicle information configured to measure a current energy source residual amount and a per-time energy source consumption, generate a path toward a destination, when a vehicle supplies electric power to the outside, calculate a total power usable time period based on the energy source residual amount, and calculate and display a power supply allowable time period for which electric power is supplied to the outside when the vehicle travels along the path, and a mobile device configured to display the total power usable time period and the power supply allowable time period received from the apparatus to display environment-friendly vehicle information via wireless communication.

In accordance with another aspect of the present disclosure, a method for displaying environment-friendly vehicle information may include measuring a current energy source residual amount and a per-time energy source consumption, generating a path toward a destination, when a vehicle supplies electric power to the outside, calculating a total power usable time period based on the energy source residual amount, calculating a power supply allowable time period for which electric power is supplied to the outside when the vehicle travels along the path, and displaying the total power usable time period and the power supply allowable time period. The method may further include outputting an alarm through a horn or an emergency light when a final margin time at which the energy source is insufficient, based on the total power usable time period or the power supply allowable time period.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of a system for displaying environment-friendly vehicle information according to an exemplary embodiment of the present disclosure;

FIG. 2 is a diagram for displaying information when an electric vehicle supplies electric power externally according to an exemplary embodiment of the present disclosure;

FIG. 3 is a diagram for displaying information when a hybrid electric vehicle supplies electric power externally according to an exemplary embodiment of the present disclosure;

FIG. 4 is a diagram for displaying information when a fuel cell electric vehicle supplies electric power externally according to an exemplary embodiment of the present disclosure;

FIG. 5 is a flowchart illustrating a method for displaying environment-friendly vehicle information according to an exemplary embodiment of the present disclosure;

FIG. 6 is an exemplary view depicting environment-friendly vehicle information when electric power is supplied externally according to an exemplary embodiment of the present disclosure by using a graph;

FIG. 7 is an exemplary view depicting environment-friendly vehicle information when electric power is supplied externally according to an exemplary embodiment of the present disclosure by using numbers;

FIG. 8 is an exemplary view depicting environment-friendly vehicle information when electric power is supplied externally according to an exemplary embodiment of the present disclosure by a bar graph; and

FIG. 9 is a diagram of a computer system, to which the method for displaying environment-friendly vehicle information when electric power is supplied externally according to an exemplary embodiment of the present disclosure is applied.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. Throughout the specification, it is noted that the same or like reference numerals denote the same or like components even though they are provided in different drawings. Further, in the following description of the present disclosure, a detailed description of known functions and configurations incorporated herein will be omitted when it may make the subject matter of the present disclosure rather unclear.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

The present disclosure discloses a configuration of calculating and providing an energy source that is necessary for a host or subject vehicle to travel toward a destination, a total power usable time period based on a current residual energy source, a power supply time period for which electric power may be supplied externally, and the like in real time when electric power in the vehicle is supplied to the outside, such as a V2G or a mobile power generation vehicle, and interrupting supply of the electric power to the outside or turning off the vehicle by providing a notification to the user using an alarm.

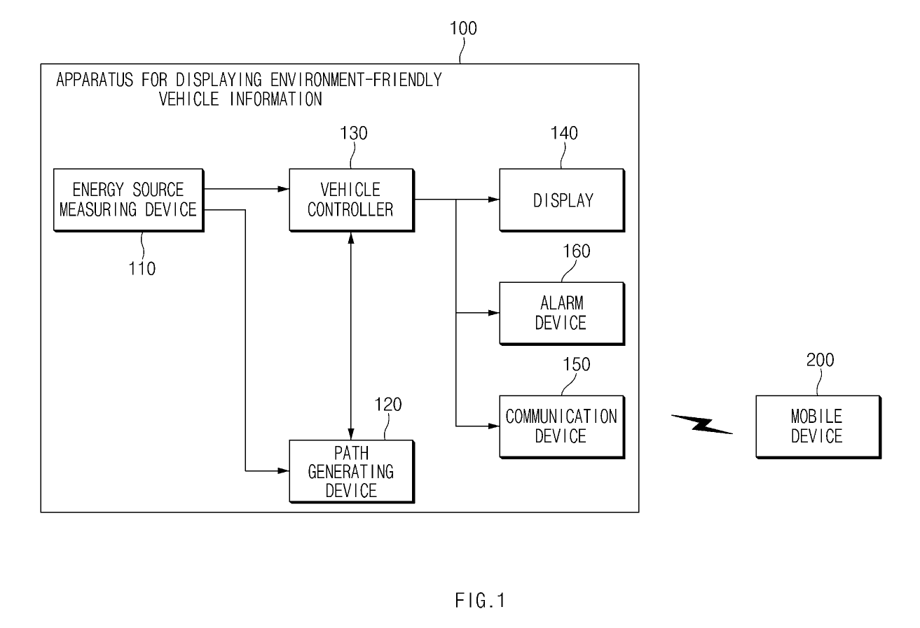

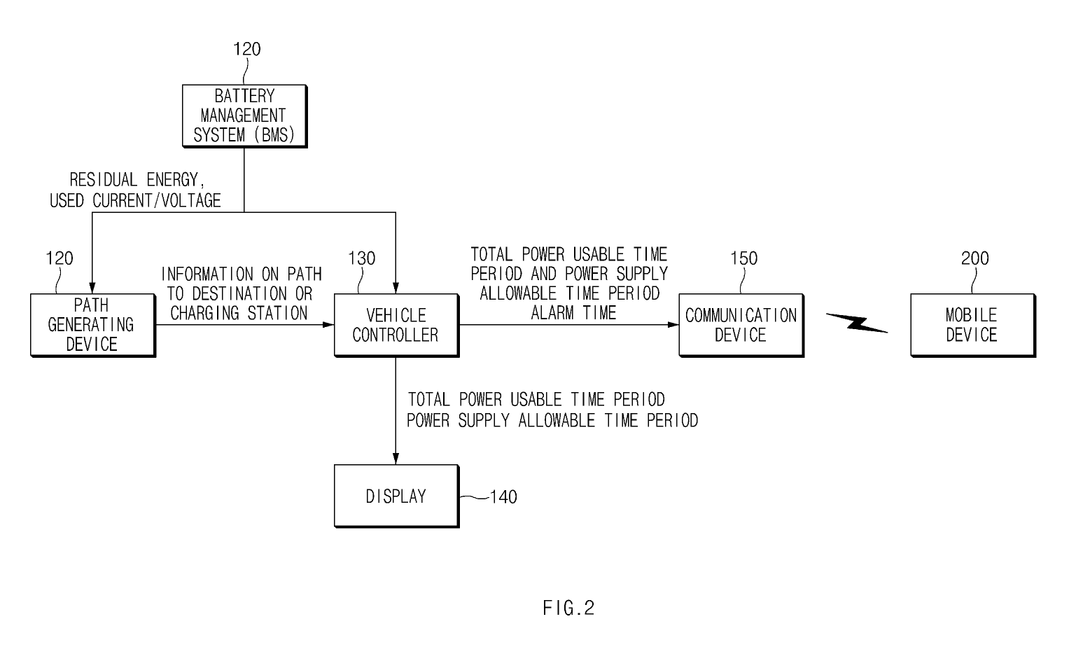

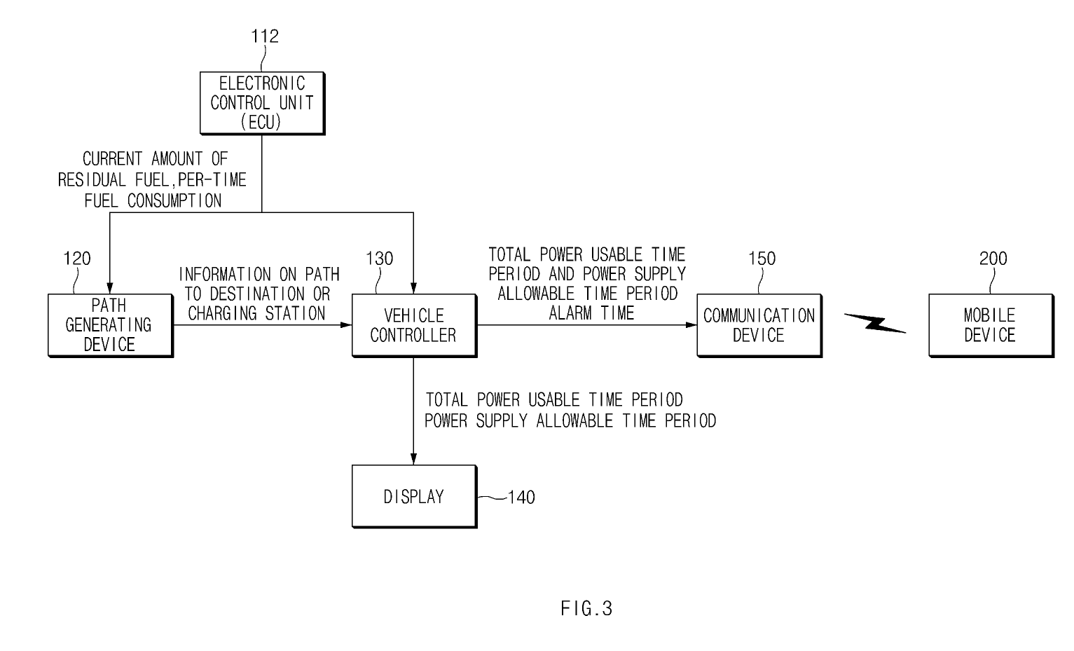

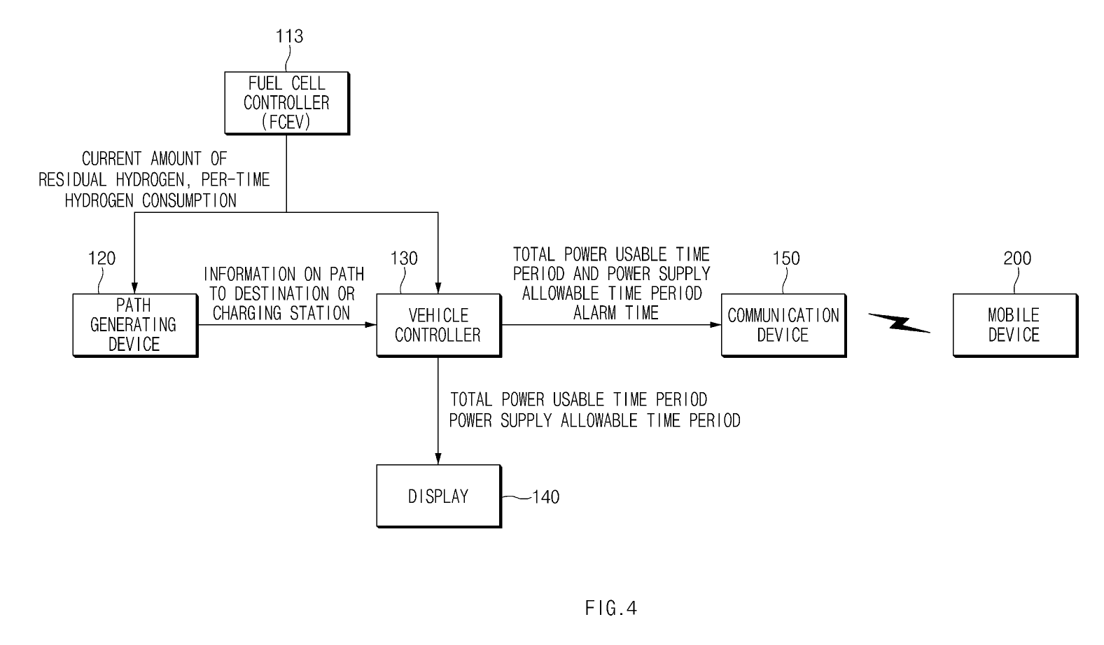

Hereinafter, exemplary embodiments of the present disclosure will be described in detail with reference to FIGS. 1 to 9. FIG. 1 is a block diagram of a system for displaying environment-friendly vehicle information according to an exemplary embodiment of the present disclosure. FIG. 2 is a diagram for displaying information when an electric vehicle (EV) supplies electric power externally according to an exemplary embodiment of the present disclosure. FIG. 3 is a diagram for displaying information when a hybrid electric vehicle (HEV) supplies electric power externally according to an exemplary embodiment of the present disclosure. FIG. 4 is a diagram for displaying information when a fuel cell electric vehicle (FCEV) supplies electric power externally according to an exemplary embodiment of the present disclosure.

The system for displaying environment-friendly vehicle information according to the exemplary embodiment of the present disclosure may include an apparatus 100 configured to display environment-friendly vehicle information and a mobile device 200 configured to perform wireless communication. In particular, the apparatus 100 used to display environment-friendly vehicle information may be configured to transmit a time period for which electric power may be supplied externally, residual power information, and the like via a text message to allow the user to verify the transmitted information.

Additionally, the apparatus 100 may be configured to calculate a power usable time period and a power supply allowable time period using a residual amount of an energy source of a host vehicle when electric power of the host power is supplied to the outside of the vehicle and provide the calculated time periods to the user to allow the user to more accurately recognize an energy source exhaustion time point as the electric power of the host vehicle (e.g., subject vehicle) is supplied externally to cope with the recognized energy source exhaustion time point. Accordingly, the apparatus 100 may include an energy source residual amount measuring device 110, a path generating device 120, a vehicle controller 130, a display 140, and a communication device 150. The various devices may be operated by a controller having a memory and a processor.

In particular, the energy source residual amount measuring device 110 may be configured to measure an energy source (e.g., an amount of electric power, an amount of fossil fuel, and a residual amount of hydrogen) currently used by the vehicle using a sensor. The path generating device 120 may be configured to generate information regarding a path toward a destination in response to a user input (e.g., user input including a destination), and when the destination is not input by a user, generate information regarding a path toward a site, such as a nearby charging station or gas station and transmit the information to the vehicle controller 130. The path generating device 130 may be a navigation terminal or an audio, video, and navigation (AVN) device. When the path generating device 120 includes a display module, a total power usable time period and a power supply allowable time period may be displayed through the path generating device 120. Further, the path generating device 120 may be configured to generate a path based on a current energy source residual amount, a per-time energy source consumption, and the like measured by the energy source residual amount measuring device 110.

When the vehicle is an electric vehicle, as illustrated in FIG. 2, the energy source residual amount measuring device 110 may be a battery management system 111, and the battery management system 111 may be configured to measure residual energy (e.g., an amount of residual electric power), an in-use current, and an in-use voltage and deliver the measured values to the vehicle controller 130. When the vehicle is a hybrid electric vehicle (HEV), as in FIG. 3, the energy source residual amount measuring device 110 may be an electronic control unit (ECU) 112, and the ECU 112 may be configured to measure an amount of fuel and a per-time fuel consumption and deliver the measured values to the vehicle controller 130.

Further, when the vehicle is a fuel cell electric vehicle (FCEV), as in FIG. 4, the energy source residual amount measuring device 110 may be a fuel cell controller 113, and the fuel cell controller 113 may be configured to measure or calculate an amount of hydrogen and a per-time hydrogen consumption and deliver the calculated values to the vehicle controller 130. When electric power is supplied to an external power generation vehicle or a V2G, the vehicle controller 130 may be configured to calculate a total power usable time period using the electric power and the residual amount of the energy source, such as a fossil fuel or hydrogen, which are measured by the energy source residual amount measuring device 110. The total usable time period refers to a total power usable time period when the current left energy is supplied externally or is used to drive the vehicle.

As in FIG. 2, when the vehicle is an electric vehicle (EV), the vehicle controller 130 may be configured to calculate an amount of used external power using residual energy, a consumed current, and a consumed voltage calculated by the battery management system 112 and calculate a total power usable time period using the amount of used external power and the residual energy. Equation 1 is an equation for calculating an amount of used external power using a consumed current and a consumed voltage, and the vehicle controller 130 may be configured to calculate an amount of used external power by multiplying the consumed current and the consumed voltage.

Amount of used external power (W)=Consumed current (A)×Consumed voltage (V) Equation 1

Equation 2 is an equation for calculating a total power usable time period, and the vehicle controller 130 may be configured to calculate a total power usable time period by dividing the residual energy by the amount of used external power.

Total power usable time period (h)=Residual energy (Wh)/Amount of used external energy (W) Equation 2

Subsequently, the vehicle controller 130 may be configured to calculate energy used to travel along the path generated by the path generating device 120, that is, path use energy. As shown in Equation 3, the vehicle controller 130 may be configured to calculate usable energy by subtracting the path use energy from the residual energy.

Usable energy (Wh)=Residual energy (Wh)−Path use energy (Wh) Equation 3

The vehicle controller 130 may then be configured to calculate a power supply allowable time period by dividing the usable energy by the amount of used external power. The power supply allowable time period refers to a time period from which the remaining energy considering the residual energy and the energy used in the travel path of the host vehicle may be supplied from the host vehicle to the external power generation vehicle.

Power supply allowable time period (h)=Usable energy (Wh)/Amount of used external energy (W) Equation 4

Moreover, as shown in FIG. 2, when the vehicle is a hybrid electric vehicle (HEV), the vehicle controller 130 may be configured to calculate a total power usable time period as shown in Equation 5 using the current residual amount of fuel and the per-time fuel consumption measured by the electronic control unit (ECU) 112. The total power usable time period refers to a total time period for which the vehicle uses the current amount of fuel to travel.

Total power usable time period (h)=Current amount of fuel (l)/Per-time fuel consumption (l/h) Equation 5

Subsequently, the vehicle controller 130 may be configured to calculate the amount of fuel used to travel along the path generated by the path generating device 120, that is, path use fuel amount. As shown in Equation 6, the vehicle controller 130 may be configured to calculate the usable fuel amount by subtracting the path use fuel amount from the residual fuel energy. The usable fuel amount refers to an amount of left fuel, that is, a residual amount of fuel that may be used in consideration of the current amount of fuel and an amount of path use fuel that is necessary during the path travel.

Amount of usable fuel (l)=Current amount of residual fuel (l)−Amount of path use fuel (l) Equation 6

As shown in Equation 7, the vehicle controller 130 may be configured to calculate a power supply allowable time period by dividing the amount of usable fuel by the per-time fuel consumption. The power supply allowable time period refers to a time period for which power may be supplied externally when power is supplied externally using the remaining amount of fuel except for the amount of fuel that necessary for the vehicle to travel to reach a destination.

Power supply allowable time period (h)=Usable fuel consumption (l)/Per-time fuel consumption (l/h) Equation 7

Meanwhile, as shown in FIG. 4, when the vehicle is a fuel cell electric vehicle (FCEV), the vehicle controller 130 may be configured to calculate a total power usable time period as in Equation 8 using the current residual amount of hydrogen and the per-time hydrogen consumption measured by the fuel cell controller 113. In other words, the vehicle controller 130 may be configured to calculate a total power usable time period by dividing the current residual amount of hydrogen by the per-time hydrogen consumption. The total power usable time period refers to a total time period for which the vehicle uses the current amount of remaining hydrogen to travel.

Total power usable time period (h)=Current amount of residual hydrogen (g)/Per-time hydrogen consumption (g/h) Equation 8

Subsequently, the vehicle controller 130 may be configured to calculate an amount of hydrogen that is necessary for the vehicle travel along the path generated by the path generating device 120, that is, a path use hydrogen amount, and may be configured to calculate a usable hydrogen amount by subtracting the current residual hydrogen amount by the path use hydrogen amount.

Amount of usable hydrogen (g)=Current amount of residual hydrogen (g)−Amount of path use hydrogen (g) Equation 9

As shown in Equation 10, the vehicle controller 130 may be configured to calculate a power supply allowable time period by dividing the amount of usable hydrogen by the per-time hydrogen consumption.

Power supply allowable time period (h)=Amount of usable hydrogen (g)/per-time hydrogen consumption (g/h) Equation 10

Accordingly, the vehicle controller 130 may be configured to calculate a total power usable time period and a power supply allowable time period, and provide the time periods to the display 140, the communication device 150, and an alarm device 160. Further, the vehicle controller 130 may be configured to provide a notification to the user indicating a final margin time has been reached (e.g., corresponding to the vehicle reaching a final destination) via the communication device 150 and the alarm device 160 when the final margin time is reached when the residual amount of the energy source of the vehicle is minimal, that is, when the energy source of the vehicle is insufficient to reach the destination or the energy source of the vehicle is used further based on the total power usable time period or the power supply allowable time period, and since the vehicle may be unable to reach the destination if the electric power is continuously supplied externally even after the alarm, the controller may be configured to interrupt the supply of electric power to the outside of the vehicle or to begin turning the vehicle off.

Furthermore, the display 140 may be configured to display the total power usable time period, the power supply allowable time period, and the like calculated by the vehicle controller 130 using a graph or numbers. The display 140 may be a cluster or an audio video navigation (AVN) device. The communication device 150 may be configured to transmit a usable time period or the like to the mobile device 200 with letters or voice through Bluetooth communication or the like. The communication device 150 may a telematics terminal or the like. Further, the communication device 150 may be configured to transmit a notification regarding reaching a final margin time when the energy source of the vehicle is insufficient or the energy source of the vehicle is used further based on the power usable time period or the power supply allowable time period.

The alarm device 160 may be configured to inform the user of a time point at which the energy source of the vehicle is exhausted through a horn or switching an emergency light on and off continuously. Further, the alarm device 160 may be configured to transmit a notification regarding the final margin time being reached when the energy source of the vehicle is insufficient or the energy source of the vehicle is used further based on the power usable time period or the power supply allowable time period through turning a horn or an emergency light on and off.

Accordingly, the present disclosure may provide the user with information on how many hours the energy of the vehicle may be used when electric power is supplied externally in the current state or until when the electric power has to be used to allow the vehicle to move safely to the next destination as well as the current SOC, the amount of fuel, and the travel distance of the vehicle in real time, when the environment-friendly vehicle supplies electric power externally (e.g., a vehicle to grid (V2G) or a mobile power generation vehicle). In other words, the present disclosure may predict a total power usable time period considering an electric power consumption in addition to a current state of a vehicle when electric power is supplied externally, and may provide information regarding an in-use time for reaching a destination, a time period for which electric power may be supplied externally, and the like to the user.

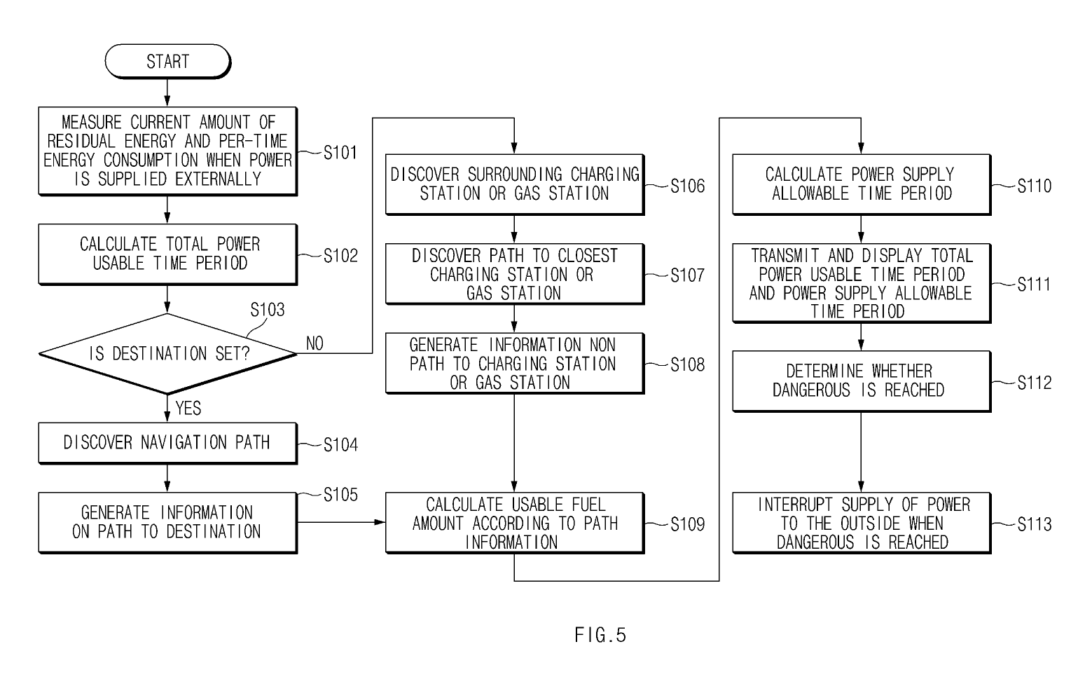

Hereinafter, a method for displaying environment-friendly vehicle information according to an exemplary embodiment of the present disclosure will be described with reference to FIG. 5. FIG. 5 is a flowchart illustrating a method for displaying environment-friendly vehicle information according to an exemplary embodiment of the present disclosure. The method described herein below may be executed by a controller having a memory and a processor.

Referring to FIG. 5, the apparatus 100 for displaying environment-friendly vehicle information may be configured to measure or calculate a current energy source residual amount and a per-time energy source consumption (S101). The apparatus 100 may then be configured to calculate a total power usable time period based on the current energy source residual amount. Subsequently, the apparatus 100 may be configured to determine whether a destination is set (S103), discover and generate a navigation path to guide a vehicle along a road toward the destination when the destination is set (S104 and S105), and calculate an energy source consumption based on the generated path information (S109).

Meanwhile, when a destination is not set, the apparatus 100 may be configured to detect a surrounding charging station or gas station (S106), set a path to a closest charging station or gas station (S107), and generate information regarding a path to the closest charging station or gas station (S108). Subsequently, the apparatus 100 may be configured to calculate an amount of energy or an energy source necessary for the vehicle to travel along the path according to the generated path information (S109).

Additionally, the apparatus 100 may be configured to calculate a power supply allowable time period using usable energy or a usable energy source necessary for the vehicle to travel along the path (S110), and display the power supply allowable time period on a screen or transmit the power supply allowable time period to the mobile device 200 of the user to provide a notification regarding the power supply allowable time period (S111). The apparatus 100 may be configured to determine whether the current energy source residual amount reaches a dangerous level (S112) (e.g., a level at which the energy source is insufficient for the vehicle to reach a destination), and interrupt the supply of electric power to the outside when the dangerous level is reached (S113).

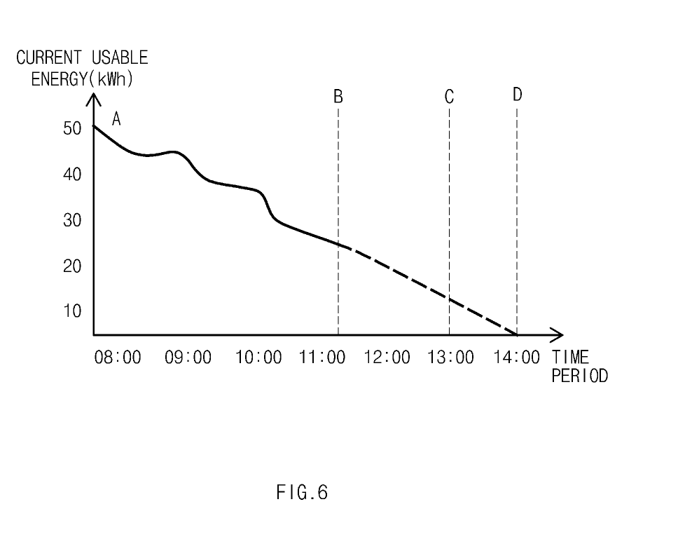

FIG. 6 is an exemplary view depicting environment-friendly vehicle information when electric power is supplied externally according to an exemplary embodiment of the present disclosure by using a graph. The present disclosure may display a total power usable time period and power supply allowable time information with a graph and numbers, and provide an alarm function to the user if necessary. Further, the present disclosure may transmit a total usable time period and power supply allowable time information to the mobile device (e.g., the smart device 200) connected to the user via the communication device 150. Referring to FIG. 6, current available energy for times is represented.

As shown in FIG. 6, the current available energy (e.g., electric power, an amount of fuel, and an amount of hydrogen) is highest at a power supply start time point A and the current available energy decreases over time due to the electric power provided to the outside. A total power usable time period and a power supply time period from the current time point B to a time point at which the energy source is exhausted in the future is calculated and indicated by a trend line (dotted line). For example, the power supply allowable time period (to point C) is a total of 2 hours (11:00 to 13:00), and a total power usable time period (to point D) is a total of 3 hours (11:00 to 14:00). Then, point C becomes a final margin time, and the user may be notified that only an amount of an energy source remains that allows the user to return home (e.g., an original start point) or to the charging station or gas station.

In other words, the apparatus 100 provides a notification to the user that power cannot be supplied externally to point C, and the alarm time may be arbitrarily set to about 10 minutes or 20 minutes before the arrival at point C or may be stored as a default value. Accordingly, when the alarm time is reached, the vehicle may output an alarm function through a method such as a horn or an emergency light. Further, the alarm time may be transmitted to the mobile device 200 of the user via Bluetooth communication or the like to notify the user through a message, a sound, or the like. Since the energy source is exhausted and the vehicle is unable to travel further when the user fails to recognize the alarm even after the alarm is output and electric power is continued to be used, the supply of the electric power may be compulsorily interrupted when the power supply allowable time C is reached. The function may be set or released by the user. In other words, the controller may be configured to operate the vehicle to be stopped or to interrupt the supply of power based on a manual operation by the user not be executed after the alarm has been output and the alarm time has elapsed.

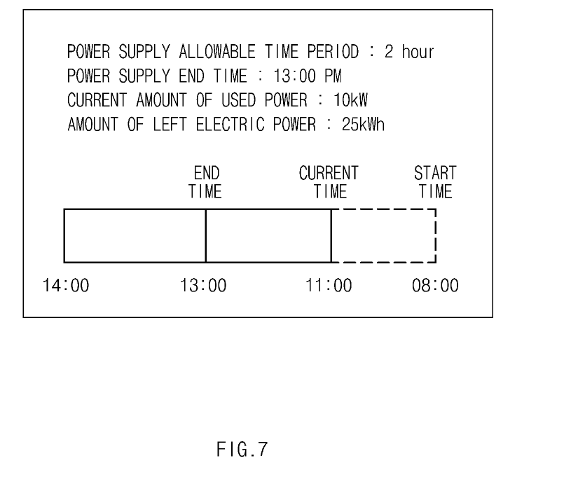

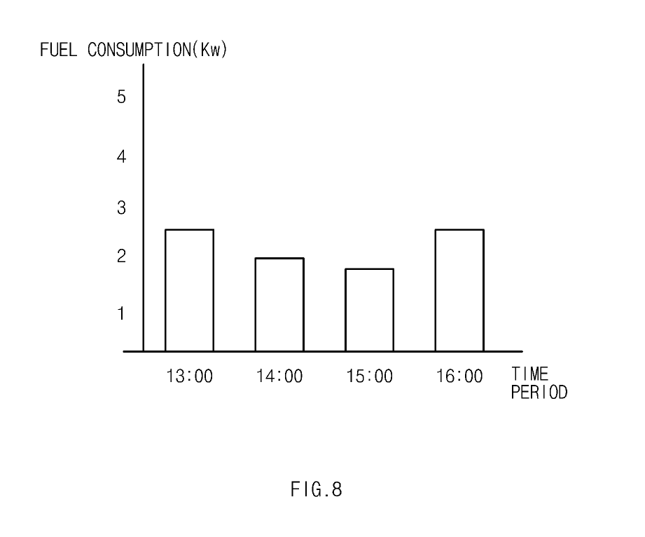

FIG. 7 is an exemplary view depicting environment-friendly vehicle information when electric power is supplied externally according to an exemplary embodiment of the present disclosure using numbers. FIG. 8 is an exemplary view depicting environment-friendly vehicle information when electric power is supplied externally according to an exemplary embodiment of the present disclosure by a bar graph.

Referring to FIG. 7, a power usable time period may be displayed with numbers instead of a graph, and may be displayed in a form of a bar graph as in FIG. 8. FIG. 8 is an example of displaying a per-time fuel consumption in a form of a bar graph. Since the user may accurately predict how much energy of a vehicle is being used, a current state of the vehicle, a total power usable time period, and the like as power consumption, usable energy, and the like may be displayed in a form of numbers, a graph, or a bar graph at a specific time period, the user may make an energy source related measure such as whether the user has to stop supply of electric power, whether electric power has to be charged, or the like. For example, since the user is capable of recognizing a current state of the energy source, the user may determine whether sufficient energy remains to reach a destination.

Further, although the present disclosure has described mainly an example of providing a total power usable time period and a power supply allowable time period, basic travel information, such as a travel allowable distance, a target state of charge (SOC), and the like, and power supply interruption time information due to exhaustion of an energy source may be provided. Since the user is actively informed of a time point at which the power supply function has to be ended and supply of electric power to the outside may be interrupted if necessary, the user may use a necessary amount of external power while not being unnecessarily concerned in the external power and the convenience of the user may be improved.

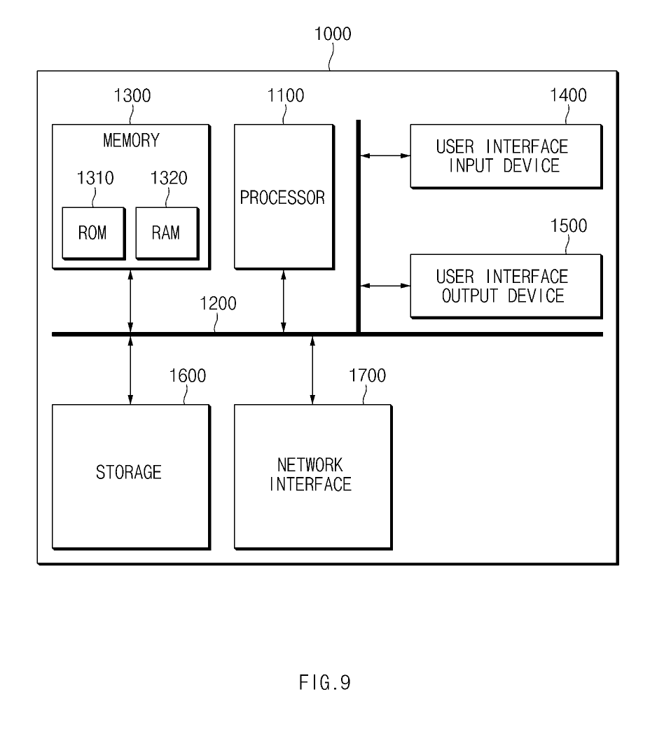

FIG. 9 is a diagram of a computer system, to which the method for displaying environment-friendly vehicle information when electric power is supplied externally according to an exemplary embodiment of the present disclosure is applied. Referring to FIG. 9, the computing system 1000 may include at least one processor 1100 connected via a bus 1200, a memory 1300, a user interface input device 1400, a user interface output device 1500, a storage 1600, and a network interface 1700.

The processor 1100 may be a central processing device (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM). Accordingly, the steps of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM memory, a flash memory, a ROM memory, an EPROM memory, an EEPROM memory, a register, a hard disk, a detachable disk, or a CD-ROM.

The exemplary storage medium may be coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component. The present technology may predict a current state, a total power usable time period, and a destination arrival allowable time of a vehicle and allow the user to more easily identify the information, thereby improving the user convenience.

The above description is a simple exemplification of the technical spirit of the present disclosure, and the present disclosure may be variously corrected and modified by those skilled in the art to which the present disclosure pertains without departing from the essential features of the present disclosure. Therefore, the disclosed embodiments of the present disclosure do not limit the technical spirit of the present disclosure but are illustrative, and the scope of the technical spirit of the present disclosure is not limited by the exemplary embodiments of the present disclosure. The scope of the present disclosure should be construed by the claims, and it will be understood that all the technical spirits within the equivalent range fall within the scope of the present disclosure.

What is claimed is:

1. An apparatus for displaying environment-friendly vehicle information, comprising:
an energy source residual amount measuring device configured to measure a current energy source residual amount and a per-time energy source consumption;
a path generating device configured to set a path toward a destination;
a vehicle controller configured to, when a vehicle supplies electric power to the outside, calculate a total power usable time period based on the energy source residual amount and supply electric power to the outside when the vehicle travels along the path; and
a display configured to display the total power usable time period and the power supply allowable time period,
wherein the vehicle controller is configured to adjust usage of the electric power based on the total power usable time period and the power supply allowable time period.

2. The apparatus of claim 1, wherein the path generating device is configured to set the path while taking a closest charging station or gas station as the destination when the destination is not set.

3. The apparatus of claim 2, wherein when the vehicle is an electric vehicle (EV), the energy source is electric energy and the vehicle controller is configured to calculate a power consumption that is a consumption of electrical power supplied to the outside using an in-use current and an in-use voltage of the vehicle.

4. The apparatus of claim 3, wherein the vehicle controller is configured to calculate path use energy that is electric energy necessary for the vehicle to travel along the path, and calculate usable energy that is energy remaining using current residual energy that is the current energy source residual amount and the path use energy.

5. The apparatus of claim 4, wherein the vehicle controller is configured to calculate the power supply allowable time period using the usable energy and the power consumption.

6. The apparatus of claim 1, wherein when the vehicle is a hybrid electric vehicle (HEV), the energy source is a fuel and the vehicle controller is configured to calculate a total power usable time period using a current residual fuel amount that is the energy source residual amount and a per-time fuel consumption.

7. The apparatus of claim 6, wherein the vehicle controller is configured to calculate a usable power consumption using the current residual fuel amount and a path use fuel amount that is an amount of a fuel necessary for the vehicle to travel along the path.

8. The apparatus of claim 7, wherein the vehicle controller is configured to calculate the power supply allowable time period using the usable fuel amount and the per-time fuel consumption.

9. The apparatus of claim 1, wherein when the vehicle is a fuel cell electric vehicle (FCEV), the energy source is a fuel and the vehicle controller is configured to calculate a total power usable time period using a current residual hydrogen amount that is the energy source residual amount and a per-time hydrogen consumption.

10. The apparatus of claim 9, wherein the vehicle controller is configured to calculate a usable power consumption using the current residual hydrogen amount and a path use hydrogen amount that is an amount of a hydrogen necessary for the vehicle to travel along the path.

11. The apparatus of claim 10, wherein the vehicle controller is configured to calculate the power supply allowable time period using the usable hydrogen amount and the per-time hydrogen consumption.

12. The apparatus of claim 1, wherein the display is configured to display the total power usable time period or the power supply allowable time period in a form of numbers, a graph, and a bar graph.

13. The apparatus of claim 1, further comprising:
a communication device configured to wirelessly transmit the total power usable time period or the power supply allowable time period to a mobile device.

14. The apparatus of claim 13, wherein the communication device is configured to transmit the total power usable time period or the power supply allowable time period to the mobile device via Bluetooth communication.

15. The apparatus of claim 14, further comprising:
an alarm device configured to output an alarm through a horn or an emergency light when a final margin time at which the energy source is insufficient, based on the total power usable time period or the power supply allowable time period.

16. The apparatus of claim 15, wherein the communication device is configured to transmit the final margin time information to the mobile device via wireless communication.

17. The apparatus of claim 16, wherein the vehicle controller is configured to compulsorily stop supply of electric power to the outside or turn off the vehicle when the electric power is continuously supplied to the outside after the alarm of the final margin time.

18. A system for displaying environment-friendly vehicle information, comprising:
an apparatus for displaying environment-friendly vehicle information configured to measure a current energy source residual amount and a per-time energy source consumption, generate a path toward a destination, when a vehicle supplies electric power to the outside, calculate a total power usable time period based on the energy source residual amount, and calculate and display a power supply allowable time period for which electric power is supplied to the outside when the vehicle travels along the path; and
a mobile device configured to display the total power usable time period and the power supply allowable time period received from the apparatus for displaying environment-friendly vehicle information via wireless communication.

19. A method for displaying environment-friendly vehicle information, comprising:
measuring, by a controller, a current energy source residual amount and a per-time energy source consumption;
generating, by a controller, a path toward a destination;
calculating, by a controller, a total power usable time period based on the energy source residual amount when a vehicle supplies electric power to the outside,
calculating, by a controller, a power supply allowable time period for which electric power is supplied to the outside when the vehicle travels along the path;
displaying, by a controller, the total power usable time period and the power supply allowable time period; and
adjusting, by the controller, usage of the electric power based on the total power usable time period and the power supply allowable time period.

20. The method of claim 19, further comprising:
outputting, by the controller, an alarm through a horn or an emergency light when a final margin time at which the energy source is insufficient, based on the total power usable time period or the power supply allowable time period.
